(19) United States
(12) Patent Application Publication
(10) Pub. No.: US 2011/0187518 A1
(43) Pub. Date: Aug. 4, 2011

(54) STEERING WHEEL HUMAN/MACHINE INTERFACE SYSTEM AND METHOD

(75) Inventors: Gary Steven Strumolo, Beverly Hills, MI (US); Jeffrey Allen Greenberg, Ann Arbor, MI (US); Yifan Chen, Ann Arbor, MI (US)

(73) Assignee: FORD GLOBAL TECHNOLOGIES, LLC, Dearborn, MI (US)

(21) Appl. No.: 12/698,359

(22) Filed: Feb. 2, 2010

(51) Int. Cl. B60Q 1/00

(52) U.S. Cl. 340/438

(57) ABSTRACT

A system and methods for communicating to a motor vehicle driver a desired direction to turn a steering wheel. The desired direction may be determined by, for example, a turn-by-turn navigation system, a lane-keeping aid system, and/or a forward collision warning system. A plurality of lights disposed on the steering wheel in a circumferentially extending array are illuminated in a pattern, the pattern comprises illuminating at least some of the plurality of lights in a repeating sequence beginning at a first position of the array away from the desired direction and progressing toward a second position of the array adjacent the desired direction. The pattern comprises a sequential illumination of the lights to communicate a direction of control action, a frequency of illumination to communicate a desired timing of the control action, and a color of illumination to communicate a positive or negative aspect.

### BACKGROUND

1. Technical Field

The present invention relates to human/machine interface systems for communicating information to a vehicle driver, and more specifically to a human/machine interface system utilizing indicator light elements on a steering wheel.

2. Background Art

Several different types of driver assistance systems for passenger vehicles have been proposed, these systems aimed at contributing to vehicle safety and passenger comfort. Such driver assistance systems include, for example, turn-by-turn navigation systems, lane-keeping aid systems, and forward collision warning systems. An important consideration in such systems is the human/machine interface (HMI), that is, the manner in which information is delivered to the driver from the vehicle systems.

For example, many known navigation systems utilize one or both of a visual map display and voice commands. Forward collision warning systems have been proposed that utilize visual, audible, and/or haptic signals delivered to the driver in a variety of ways. Likewise, lane-keeping systems have been proposed which utilize visual, audible, and/or haptic alerts.

Ideally, a driver assistance system should include an HMI that can unambiguously and intuitively communicate instructions, information, and/or warnings. As the number and complexity of driver assistance and vehicle entertainment systems increase it becomes both more difficult and more important to communicate intuitively and unambiguously with the driver. The nature of the directions and/or alerts will vary depending on the particular system involved, resulting in the driver having to interpret a wide range of visual and/or audible signals.

### SUMMARY

Embodiments of the present invention described herein are directed toward methods and systems for communicating to a driver of a motor vehicle a desired control action, such as a direction in which to turn a steering wheel. The desired direction may be determined by, for example, a turn-by-turn navigation system, a lane-keeping aid system, and/or a forward collision warning system.

In a first disclosed embodiment, a method of communicating to a driver of a motor vehicle a desired direction in which to turn a steering wheel comprises illuminating a plurality of lights disposed on the steering wheel in a circumferentially extending array in a pattern, and the pattern comprises illuminating at least some of the plurality of lights in a repeating sequence beginning at a first position of the array away from the desired direction and progressing toward a second position of the array adjacent the desired direction.

According to a second disclosed aspect of the invention, a human/machine interface (HMI) system for a motor vehicle comprises a steering wheel; a plurality of lights disposed on the steering wheel in an array extending circumferentially around a perimeter of the steering wheel; and an illumination controller generating output signals that selectively illuminate the plurality of lights in a pattern indicating a direction of desired steering wheel rotation. The pattern comprises illuminating at least some of the lights in a repeating sequence progressing toward the desired direction.

According to a third disclosed aspect of the invention, a method of communicating to a driver of a motor vehicle a vehicle control action comprises illuminating a plurality of lights disposed on a steering wheel in a circumferentially extending array in a pattern to communicate the vehicle control action, the pattern comprising a sequential illumination of the lights to communicate a direction of the control action, a frequency of illumination to communicate a desired timing of the control action, and a color of illumination to communicate a positive or negative aspect.

### BRIEF DESCRIPTION OF THE DRAWINGS

FIG. 1 is a schematic depiction of a human/machine interface system for a motor vehicle according to an embodiment of the invention;

FIG. 2 depicts a steering wheel indicator light array illuminated in a first pattern communicating a desired turn of the steering wheel to the right;

FIG. 3 depicts a steering wheel indicator light array illuminated in a second pattern communicating a desired turn of the steering wheel to the left;

FIG. 4 depicts a steering wheel indicator light array illuminated in a third pattern communicating a desired turn of the steering wheel to the right;

FIG. 5 depicts a steering wheel indicator light array illuminated in a fourth pattern communicating a desired turn of the steering wheel to the left;

FIG. 6 depicts a steering wheel indicator light array illuminated in a fifth pattern communicating an undesired movement of the vehicle to the left; and

FIG. 7 depicts a steering wheel indicator light array illuminated in a sixth pattern communicating a collision warning.

### DETAILED DESCRIPTION OF THE EMBODIMENTS

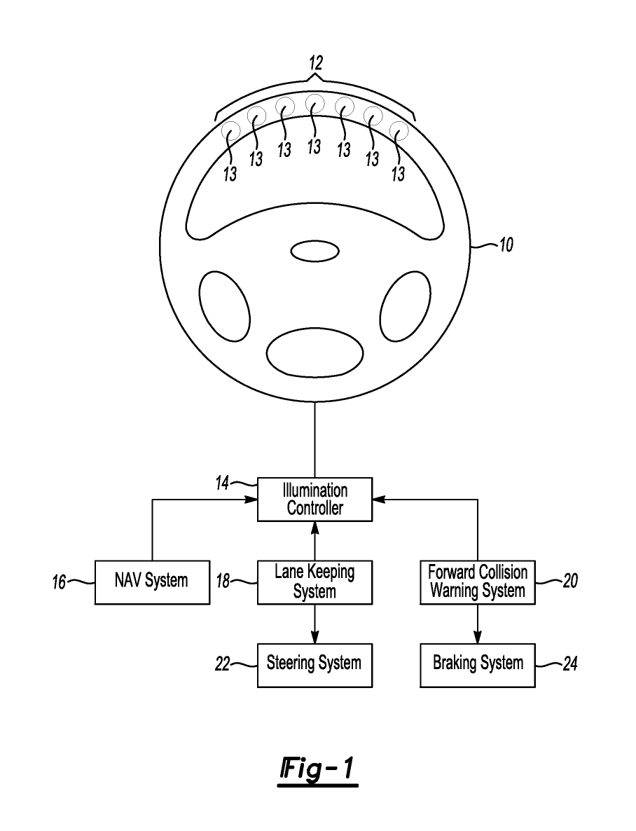

Referring to FIG. 1, a human/machine interface (HMI) system for a motor vehicle (not shown) includes a steering wheel 10 having an indicator light array 12. Indicator light array 12 is comprised of a plurality of light elements 13 disposed in a circumferentially extending array around the perimeter of the steering wheel 10. An illumination controller 14 is in electrical communication with indicator light array 12 and generates output signals that selectively and individually illuminate the light elements 13 of the array. As will be discussed in greater detail below, the illumination controller 14 and indicator light array 12 produce various patterns of light element activation to convey various types of information and/or instructions to a vehicle driver (not shown).

Illumination controller 14 receives information from one or more electronic systems, such as a navigation system 16, a lane-keeping aid system 18, and a forward collision warning system 20. Navigation system 16 may be a GPS-based system which is able to provide turn-by-turn directions to the vehicle driver in accordance with a desired route of travel. Navigation system 16 may also provide information on the desired route to the driver via a map display (not shown) and/or audible signals, as is well known in the art.

Lane-keeping aid system 18 is an electronic system of the type well known in the vehicle safety art that may utilizes various types of sensors (radar, optical, sonar, etc.) to detect lane markings in the roadway ahead of the vehicle. Lane-keeping system 18 may provide warnings to the driver if the vehicle begins to depart from the lane in which it is traveling, instructions to the driver to take corrective steering action, and/or instructions to a vehicle steering system 22 in order to produce automatic steering inputs to maintain the vehicle in the proper roadway lane, as is well-known in the art.

Forward collision warning system 20 is an electronic system of the type well known in the vehicle safety art that may utilizes various types of sensors (radar, optical, sonar, etc.) to detect obstacles (such as other vehicles, fixed objects, and/or pedestrians) in the path of the vehicle. Forward collision warning system 20 may provide warnings to the driver if the vehicle is in danger of colliding with an obstacle, instructions to the driver to take corrective braking action, and/or instructions to a braking system 24 in order to provide automatic braking of the vehicle to prevent a collision or slow the vehicle prior to a collision, as is well-known in the art.

Illumination controller 14 receives signals from one or more of navigation system 16, lane-keeping system 18, and forward collision warning system 20 and activates one or more of light elements 13 in a pattern or sequence to convey the desired information to the vehicle driver in an easily understandable and intuitive manner. Light elements 13 may be light emitting diodes (LEDs), as is well known in the art, which may be illuminated in various colors. Each of the light elements 13 may be a single, multi-color LED or may comprise several single-color LEDs for each of the desired colors.

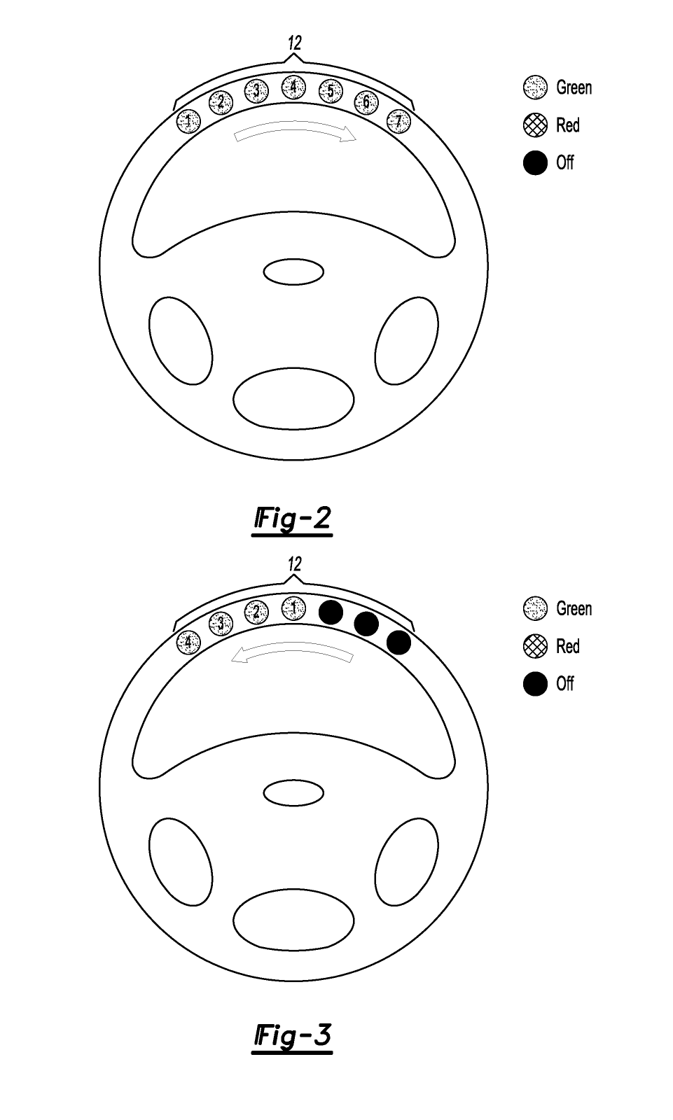

Referring now to FIG. 2, steering wheel 10 is shown with array 12 illuminated in a pattern to indicate a desired turn to the right, such as may be directed by navigation system 16 when delivering turn-by-turn directions. The number of light elements 13 shown in FIG. 2 is presented only as an example, as any number of light elements may be used. Also, the portion of the steering wheel circumference covered by the indicator light array 12 may be greater than or less than the example shown. To indicate a desired right turn, light elements 13 are individually illuminated in a sequence originating adjacent the left side of steering wheel 10 and progressing toward the right side of the steering wheel. In the exemplary embodiment shown in FIG. 2, the numerals 1 through 7 associated with individual light elements 13 indicate the order in which the light elements are illuminated. Illuminating the light elements 13 in such a sequence creates a signalling pattern that progresses from left to right. The sequence is repeated two or more times and preferably continuously as the vehicle approaches the desired turn point. In one possible embodiment of the invention, the repetition frequency of the repeating sequence 1 through 7 increases as the vehicle approaches the action point. This increasing frequency has been found to provide an intuitive and easily understood signal to the driver that the action point is approaching. The action point is defined as a point in time and/or space at which the desired action (initiating a turn by turning the steering wheel 10) should be taken to efficiently an/or safely execute the desired/directed action.

Referring now to FIG. 3, a signalling pattern according to an alternative embodiment of the invention is shown to include illuminating only a subset of the available light elements 13. The repeating sequence of illumination begins at the light element near the center (12 o'clock) position of steering wheel 10, identified as 1, and progresses around the circumference of the steering wheel to the left in order to indicate a desired left turn. The remaining light elements 13 on the right portion of steering wheel 10 are not illuminated.

In the embodiments shown in FIGS. 2 and 3, the color of the illumination of light elements 13 may be selected to provide an indication to the driver that the direction being indicated by the illumination pattern is a desired or correct direction. For example, most people with an American or European cultural background understand the color green to indicate a positive intent. In other cultures, some other color may have a positive connotation, for example red in some Asian cultures. For the rest of this document, the color connotations will be established as follows: green is a color indicating a positive or desired intent or result, and red is a color indicating a negative or undesired intent or result.

In another possible embodiment of the invention, one or more of the light elements 13 may be illuminated in a color other than green to indicate that the vehicle has reached or traveled beyond an action point. For example, the action point may be the point in time or space at which the turn in the desired direction should have been performed. One or more or indicator light elements 13 may be illuminated in yellow, for example, in a steady or flashing manner to communicate to the driver that the desired turn has been missed and that the navigation system 16 is recalculating a desired route.

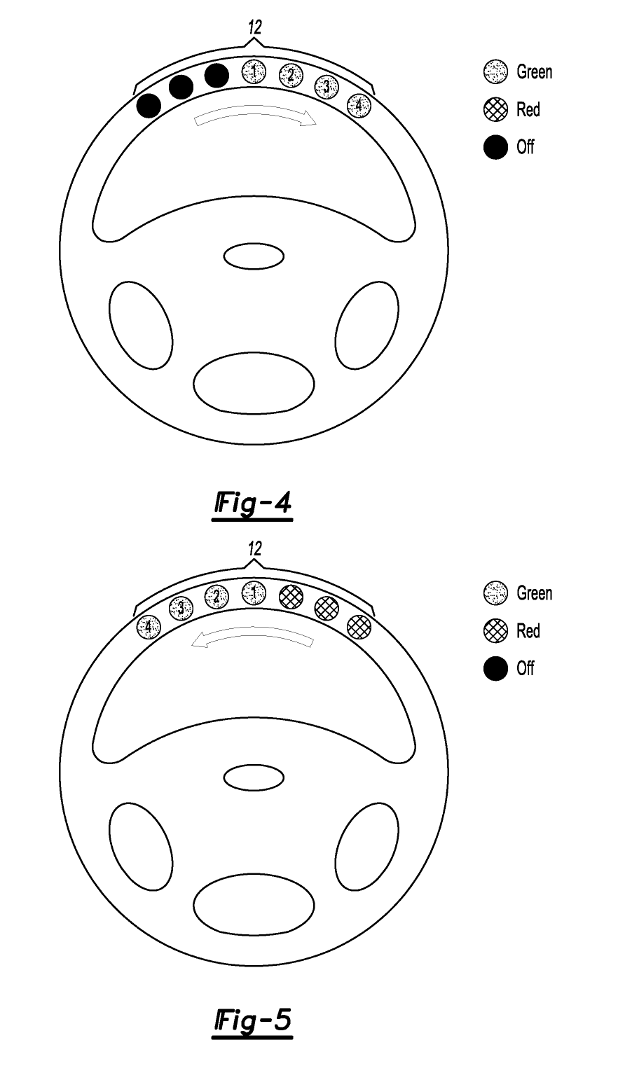

Referring now to FIG. 4, the indicator light array 12 is shown activated in a manner to advise the driver of a direction to turn steering wheel 10 to prevent the vehicle from straying out of a desired travel lane of a roadway as detected by, for example, lane-keeping system 18. In this example, the vehicle is assumed to be moving to the left or otherwise departing from the desired travel lane on the left side. To communicate the desired corrective action of turning the steering wheel to the right, a subset of light elements 13 included in array 12 are illuminated in a sequential pattern beginning at a position away from the desired turn direction and progressing toward the desired turn direction. The numerals 1 through 4 associated with the light elements 13 indicate the sequence in which the light elements of the subset are illuminated. The color of illumination is preferably green to indicate a positive action. The repetition frequency of the repeating sequence may increase if the vehicle continues its undesired movement out of the desired lane and no corrective action is taken. The brightness of the illumination may also be increased to communicate an increased urgency of taking the indicated corrective action.

FIG. 5 shows another possible version of a lane-keeping aid advisory. In this embodiment, in addition to the subset of light elements being illuminated in a repeating sequence to indicate the desired turn direction, one or more light elements making up a second subset on the side of the steering wheel closest to the direction of undesired movement are illuminated in a different color, such as red, to indicate a negative condition. The red lights may be illuminated in a blinking/flashing manner or the illumination may be steady. In the example of FIG. 5, the pattern indicates that the vehicle has begun an undesired movement to the right, and that the desired corrective action is to turn steering wheel 10 toward the left. The subset of red light elements may illuminate when the lane departure condition is initially detected or they may be illuminated only if the directed corrective steering action is not taken in a timely manner.

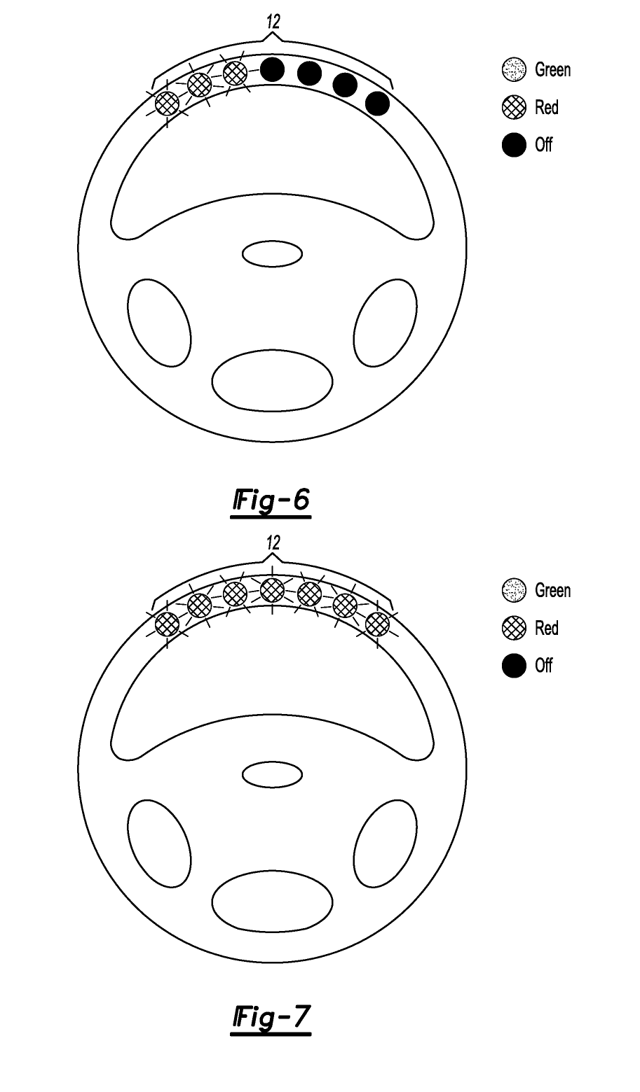

Another possible implementation of a lane-keeping aid system is shown in FIG. 6. One or more of light elements 13 located on the side of steering wheel 10 adjacent to the direction of undesired lane departure are illuminated in a red/negative color. The light elements 13 may be illuminated in a steady or blinking fashion. In contrast with the embodiments of FIGS. 4 and 5, in this version there is no positive indication of which direction to turn the steering wheel, but simply a warning that the vehicle is moving out of a desired lane in the direction indicated by the lights.

Referring now to FIG. 7, an indicator light array 12 is shown illuminated in a manner to indicate a danger of collision with an obstacle as determined by forward collision warning system 20. In this embodiment, one or more light elements 13 located generally centrally on steering wheel 10 are illuminated in a red/negative color. Light elements 13 may be illuminated steady or in a flashing or blinking manner. This signal is intended to alert the driver to a dangerous condition existing generally directly ahead of the vehicle, and no instruction to steer in a desired direction is provided. It is also possible to provide a “caution” alert in a first color (such as yellow) when a potential collision situation is detected and progress to a “warning” alert in a second color (such as red) when the collision danger passes a certain probability threshold.

In the embodiments described above, it may be seen that the illumination of the light elements 13 is performed to generate a pattern to communicate to the driver a vehicle control action, such as turning the steering wheel to change the direction of travel of the vehicle. The illumination pattern may comprise a sequential illumination of the lights to communicate a direction of the control action, a frequency of illumination to communicate a desired timing of the control action, and a color of illumination to communicate a positive or negative aspect related to the driving environment and/or the control action.

While the best mode for carrying out the invention has been described in detail, those familiar with the art to which this invention relates will recognize various alternative designs and embodiments for practicing the invention as defined by the following claims.

It is also understood, of course, that while the form of the invention herein shown and described constitutes a preferred embodiment of the invention, it is not intended to illustrate all possible forms thereof. It should also be understood that the words used in the specification are words of description rather than limitation and various changes may be made without departing from the spirit and scope of the invention.

What is claimed:

1. A method of communicating to a driver of a motor vehicle a desired direction to turn a steering wheel comprising:
luminating a plurality of lights disposed on the steering wheel in a circumferentially extending array in a pattern, the pattern comprising:
luminating at least some of the plurality of lights in a repeating sequence beginning at a first position of the array away from the desired direction and progressing toward a second position of the array adjacent the desired direction.

2. The method of claim 1 further comprising:
performing the repeating sequence in a first subset of the array located on a first side of the steering wheel and in a first color, and illuminating a second subset of the array located on a second side of the steering wheel opposite the first side in a second color.

3. The method of claim 1 wherein a repetition frequency of the repeating sequence increases as the vehicle approaches a turn point.

4. The method of claim 1 wherein the pattern further comprises:
illuminating in a second color at least some of the lights of the array when the vehicle has passed an action point.

5. The method of claim 1 further comprising illumining at least some of the lights of the array to indicate a warning condition to the driver.

6. The method of claim 1 wherein the desired direction is determined by a vehicle navigation system.

7. The method of claim 1 wherein the desired direction is determined by a lane keeping aid system.

8. A human/machine interface system for a motor vehicle comprising:
a steering wheel;
a plurality of lights disposed on the steering wheel in an array extending circumferentially around a perimeter of the steering wheel; and
an illumination controller generating output signals selectively illuminating the plurality of lights in a pattern indicating a direction of desired steering wheel rotation, the pattern comprising illuminating at least some of the lights in a repeating sequence progressing toward the desired direction.

9. The human/machine interface system of claim 8 wherein the array of lights is organized into at least a first subset located on a first side/portion of the steering wheel and a second subset located on a second side/portion of the steering wheel, the repeating sequence taking place in the first subset of lights in a first color, and the pattern further comprising illuminating at least some of the lights in the second subset in a second color.

10. The human/machine interface system of claim 8 wherein the output signals further illuminate at least some of the lights of the array in a second color when the vehicle has passed an action point.

11. The human/machine interface system of claim 8 wherein the output signals further illuminate at least some of the lights of the array to indicate a warning condition to the driver.

12. The human/machine interface system of claim 8 wherein the illumination controller receives signals from a vehicle navigation system.

13. The human/machine interface system of claim 8 wherein the illumination controller receives signals from a lane keeping aid system.

14. A method of communicating to a driver of a motor vehicle a vehicle control action comprising:
illuminating a plurality of lights disposed on a steering wheel in a circumferentially extending array in a pattern to communicate the vehicle control action, the pattern comprising a sequential illumination of the lights to communicate a direction of the control action, a frequency of illumination to communicate a desired timing of the control action, and a color of illumination to communicate a positive or negative aspect.

15. The method of claim 14 wherein sequential illumination comprises illuminating at least some of the plurality of lights in a repeating sequence beginning at a first position of the array away from the direction of control action and progressing toward a second position of the array adjacent the direction of control action.

16. The method of claim 15 wherein the pattern comprises performing the repeating sequence in a first subset of the array located on a first side of the steering wheel and in a first color, and illuminating a second subset of the array located on a second side of the steering wheel opposite the first side in a second color.

17. The method of claim 14 wherein a repetition frequency of the repeating sequence increases as the desired timing of the control action approaches.

18. The method of claim 15 wherein the pattern comprises the pattern further comprises illuminating in a second color at least some of the lights of the array when the vehicle has passed an action point.

19. The method of claim 14 wherein the vehicle control action is determined by a vehicle navigation system.

20. The method of claim 14 wherein the vehicle control action is determined by a lane keeping aid system.
